(19) United States
(12) Patent Application Publication
(10) Pub. No.: US 2013/0010290 A1
(43) Pub. Date: Jan. 10, 2013

(54) SURFACE INSPECTION DEVICE AND SURFACE INSPECTION METHOD

(75) Inventors: Kazuo Takahashi, Ninomiya (JP); Takahiro Jingu, Takasaki (JP)

(73) Assignee: HITACHI HIGH-TECHNOLOGIES CORPORATION, Tokyo (JP)

(21) Appl. No.: 13/577,348

(22) PCT Filed: Mar. 30, 2011
(86) PCT No.: PCT/JP11/57933

§ 371 Date: Aug. 6, 2012

(30) Foreign Application Priority Data
Mar. 30, 2010 (JP) 2010-078057

(51) Int. Cl. G01N 21/956

(52) U.S. Cl. 356/237.4

(57) ABSTRACT

There are provided a surface inspection device and a surface inspection method which can inspect a surface of a test object with uniform detection sensitivity. A surface inspection device includes a test object moving stage, a lighting device, an inspection coordinate detection device, a light detector, an A/D converter, and a foreign object/defect determination unit. The lighting device is configured to change a dimension of a light spot in a circumferential direction based on a position of the light spot in a radial direction obtained by the inspection coordinate detection device. The density of irradiation light intensity of the light spot is made constant while the light spot is being moved for scanning between an outer peripheral portion and a central portion on the test object.

### TECHNICAL FIELD

This invention relates to a technique for inspecting a surface of a test object. More specifically, it relates to a technique for inspecting the surface by analyzing light scattering.

### BACKGROUND ART

In manufacturing processes of a semiconductor device, a circuit is formed by transferring a pattern onto a bare wafer and etching the wafer. In the course of manufacturing the circuit, in some cases, a foreign object adheres to a surface of the bare wafer or a defect occurs on the surface. This is a major factor of yield decline. Surface inspection is carried out in each manufacturing process in order to control foreign objects adhering to the bare wafer surface or defects thereon. Such foreign objects adhering to the bare wafer surface or defects present on the wafer surface are detected at high sensitivity and high throughput by a surface inspection device.

Methods of inspecting a wafer surface include a method using charged particle beams such as an electron beam and an optical method using light. The optical method includes a method of capturing an image of a wafer surface with a camera and analyzing image information, and a method of detecting light scattered on a wafer surface by using a photodetector such as a photomultiplier tube and analyzing the degree of the light scattering. Patent Document 1 describes an example of the latter method.

### CITATION LIST

### Patent Literature

Patent Document 1: Japanese Patent Publication (Kokai) No. S63-143830 (1988)

Patent Document 2: U.S. Pat. No. 7,548,308

Patent Document 3: Japanese Patent Publication (Kokai) No. 2008-20362

### SUMMARY OF INVENTION

### Technical Problem

In general, the method of analyzing light scattering includes radiating a laser beam onto a wafer surface and detecting scattered light from a foreign object by using a detector. A signal from the detector is converted into a digital signal by A/D conversion and the size of the foreign object or defect is calculated from such digital data. A method in which an inspection table loaded with a work (wafer) is moved in a horizontal direction while rapidly rotated is employed in order to achieve high inspection throughput. In this method, a trajectory of a light spot on the work is spiral. A map of foreign objects and defects on the entire work surface is calculated based on size information of the foreign objects and defects and on coordinate information thereof acquired from a stage.

Since the work is rapidly rotated in the method of analyzing light scattering, the linear velocity of the work in a circumferential direction is great at an outer peripheral portion and small at a central portion. In the meantime, the dimension of the light spot of the laser beam is set constant and remains the same at the outer peripheral portion and the central portion. Accordingly, the density of irradiation light intensity per unit time is small at the outer peripheral portion and great at the central portion.

In general, detection sensitivity SNR for a foreign object or defect is proportional to a square root of the density of irradiation light intensity as defined by the following formula.

SNR∝√((P×Δt)÷s)×√λ Formula 1

SNR: signal to noise ratio

P: amount of laser beam

Δt: irradiation time

s: area of light spot

λ: laser wavelength

Accordingly, the detection sensitivity SNR for a foreign object or defect is low at the outer peripheral portion and high at the central portion. In other words, a variation or fluctuation in inspection accuracy is likely to occur in a conventional surface inspection device.

An object of the present invention is to provide a surface inspection device and a surface inspection method which can inspect a surface of a test object with uniform detection sensitivity.

### Solution to Problem

A surface inspection device of the present invention includes: a test object moving stage configured to move a test object straight in a radial direction while rotating the test object; a lighting device configured to form a light spot of a laser beam on a surface of the test object; an inspection coordinate detection device configured to detect a position of the light spot on the test object; a light detector configured to detect scattered light from the light spot and to convert the scattered light into an electrical signal; an A/D converter configured to convert the electrical signal into digital data; and a foreign object/defect determination unit configured to determine whether there is any of a foreign object and a defect on the surface of the test object based on the digital data obtained by the A/D converter.

The lighting device is configured to change a dimension of the light spot in a circumferential direction based on a position of the light spot in the radial direction obtained by the inspection coordinate detection device, and is configured to make density of irradiation light intensity of the light sport constant while the light spot is being moved for scanning between an outer peripheral portion and a central portion on the test object.

### Advantageous Effects of Invention

According to the present invention, there are provided a surface inspection device and a surface inspection method which can inspect a surface of a test object with uniform detection sensitivity.

### BRIEF DESCRIPTION OF DRAWINGS

FIG. 1 is a view showing a schematic configuration of an example of a surface inspection device of the present invention.

FIG. 2A is a view showing an example of a lighting device according to the surface inspection device of the present invention.

FIG. 2B is a view showing a light spot according to the surface inspection device of the present invention.

FIG. 3 is a view showing variations of the light spot according to the surface inspection device of the present invention.

FIG. 4 is a view showing an optical density of irradiation light intensity according to the surface inspection device of the present invention.

FIG. 5A is a view showing signal frequency characteristics according to a typical surface inspection device.

FIG. 5B is a view showing signal frequency characteristics according to the surface inspection device of the present invention.

FIG. 6 is a view showing an operation of a variable filter according to the surface inspection device of the present invention.

FIG. 7 is a view showing amounts of scanning according to the surface inspection device of the present invention.

FIG. 8 is a view for explaining processing to change the light spot according to the surface inspection device of the present invention.

### DESCRIPTION OF EMBODIMENTS

An embodiment of the present invention will be described below with reference to the drawings. It is to be noted that a device and a method of the present invention are not limited only to the configurations illustrated in the drawings but various modifications are possible within the range of technical ideas thereof.

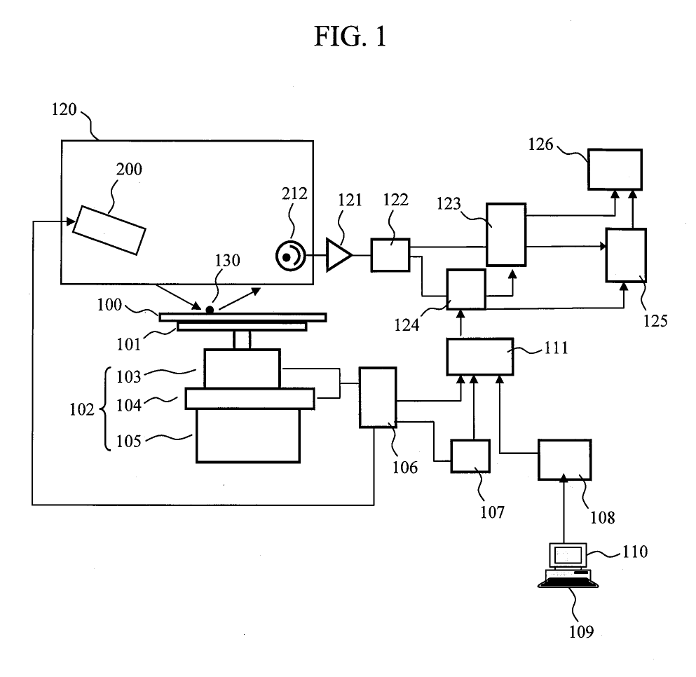

FIG. 1 shows an example of a surface inspection device for inspecting a foreign object or defect, according to the present invention. The surface inspection device of this example includes a chuck 101 configured to support a test object by vacuum chuck, an illumination and detection optical system 120 configured to irradiate the test object with illumination light and to detect scattered light therefrom, and a moving stage 102 configured to move the test object supported by the chuck 101. Here, a semiconductor wafer 100 will be described as an example of the test object. The illumination and detection optical system 120 includes a lighting device 200 and a light detector 212. The test object moving stage 102 includes a rotary stage 103 configured to rotate the test object, a rectilinear stage 104 configured to move the test object in X and Y directions, and a Z stage 105 configured to move the test object in a Z direction.

The rotary stage 103 and the rectilinear stage 104 of the moving stage 102 can rotate the semiconductor wafer 100 and move the semiconductor wafer 100 in a radial direction at the same time. That is, with lapse of time, the moving stage 102 can change a combination of a rotational movement θ and a rectilinear movement R in a horizontal direction. A light spot is formed on the semiconductor wafer 100 by a laser beam from the lighting device 200. Since the semiconductor wafer 100 performs the rotational movement and the rectilinear movement, the light spot can be moved on the semiconductor wafer 100 spirally for scanning. Here, scanning in a circumferential direction will be referred to as main scanning and scanning in the radial direction will be referred to as sub-scanning.

The surface inspection device of this example further includes a foreign object/defect determination system, a foreign object/defect coordinate detection system, a host CPU 108, an input device 109, and a display device 110. The foreign object/defect determination system includes an amplifier 121, an A/D converter 122, a subtractor 123, a variable filter 124, a defect determination mechanism 125, and a particle size calculation mechanism 126.

The foreign object/defect detection system includes an inspection coordinate detection mechanism 106, a foreign object/defect coordinate detection mechanism 107, and a parameter computing unit 111. The inspection coordinate detection mechanism 106 detects a main scanning coordinate position θ and a sub-scanning coordinate position R of the light spot on the semiconductor wafer 100. An optical-scan rotary encoder is used for detection of the main scanning coordinate position θ. An optical-scan linear encoder is used for detection of the sub-scanning coordinate position R. However, a sensor based on any other detection principles is applicable as long as such a sensor can detect an angular or linear position at high accuracy.

An outline of operations of the surface inspection device for foreign objects and defects of this example will be described. The illumination light from the lighting device 200 is radiated onto the semiconductor wafer 100. The scattered light from a foreign object or defect 130 on the semiconductor wafer 100 is detected by the light detector 212. A scattered light detection signal from the light detector 212 is amplified by the amplifier 121, sampled at each sampling interval ΔT by the A/D converter 122, and converted into digital data. The digital data from the A/D converter 122 is subjected to digital filter processing by the variable filter 124 and the subtractor 123 and thereby undesired signal components such as noise are removed therefrom.

A scattered light intensity value obtained by using the variable filter 124 and the subtractor 123 is compared with a predetermined threshold by the foreign object/defect determination mechanism 125. The foreign object/defect determination mechanism 125 generates foreign object/defect determination information when the scattered light intensity value is equal to or above the threshold, and delivers the information to the particle size calculation mechanism 126 and the foreign object/defect coordinate detection mechanism 107. The particle size calculation mechanism 126 calculates the size of the detected foreign object or defect by using the scattered light intensity value.

The inspection coordinate detection mechanism 106 detects the main scanning coordinate position θ and the sub-scanning coordinate position R of the light spot on the semiconductor wafer 100 and delivers such information to the foreign object/defect coordinate detection mechanism 107 and the parameter computing unit 111. The foreign object/defect coordinate detection mechanism 107 calculates a coordinate position of the detected foreign object or defect based on the positional information from the inspection coordinate detection mechanism 106 and provides the coordinate position to the parameter computing unit 111.

Meanwhile, a user sets up the number of revolutions of the test object moving stage and the size of the light spot by means of the input device 109. These pieces of information are computed by the host CPU 108 and delivered to the parameter computing unit 111.

On the basis of the pieces of information from the inspection coordinate detection mechanism 106, the foreign object/defect coordinate detection mechanism 107, and the host CPU 108, the parameter computing unit 111 controls a cut-off frequency which is an example of parameters for the variable filter 124. Specifically, the cut-off frequency is controlled based on the main scanning coordinate position θ as well as the sub-scanning coordinate position R of the semiconductor wafer 100, the coordinate position of the foreign object or defect, the number of revolutions of the test object moving stage, and the size of the light spot. The control of the cut-off frequency will be described further in detail.

A keyboard or a pointing device such as a mouse may be used as the input device 109. Alternatively, an independent memory storing the necessary information mentioned above may be inputted to the surface inspection device via an unillustrated interface. As described above, in this embodiment, a light scattering signal obtained by the light detector 212 is converted into digital data, undesired signal components such as noise are removed from the digital data through the processing by the variable filter, and then the size of a foreign object or defect is calculated.

A feature of the present invention is to control the lighting device 200 and thereby change a dimension of the light spot based on the position of the light spot on the semiconductor wafer 100 obtained by the inspection coordinate detection mechanism 106. Now, details will be described below.

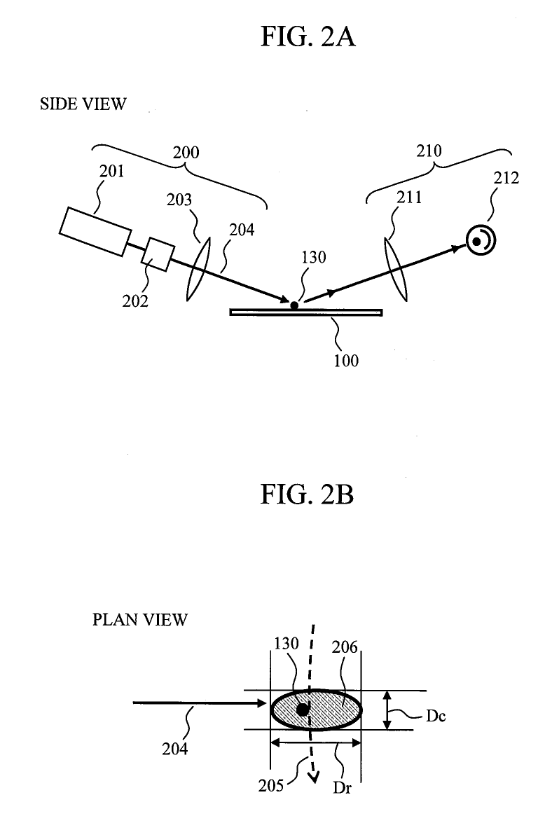

The illumination and detection optical system 120 located above the semiconductor wafer 100 will be described with reference to FIG. 2A. The illumination and detection optical system 120 includes the lighting device 200 and a detection optical system 210. The lighting device 200 includes a light source 201, a beam expander 202, and an irradiation lens 203. The detection optical system 210 includes a condenser lens 211 and the light detector 212. A laser light source is used for the light source 201. An irradiation beam 204 from the light source 201 is passed through the beam expander 202 and the irradiation lens 203 and is radiated onto the semiconductor wafer 100. The foreign object or detect 130 is attached to the semiconductor wafer 100.

The condenser lens 211 is configured to be capable of collecting scattered light at a low elevation angle so that the lens can efficiently capture the scattered light attributed to a tiny foreign object in accordance with Rayleigh scattering, for instance. Thus, the scattered light from the foreign object or defect 130 is collected by the condenser lens 211 and detected by the light detector 212. The scattered light detection signal is obtained from the light detector 212. Although a photomultiplier tube is used as the light detector 212 in this embodiment, a light detector based on any other detection principles is applicable as long as such a light detector can detect scattered light from a foreign object at high sensitivity.

The light spot on the semiconductor layer 100 will be described with reference to FIG. 2B. The irradiation beam 204 from the lighting device 200 forms a light spot 206 of a predetermined size on the semiconductor wafer 100. The irradiation beam 204 is p-polarized light, for example. The irradiation beam 204 is obliquely incident on a surface of the semiconductor wafer 100 being the test object substantially at Brewster's angle with respect to crystalline Si. Thus, the light spot 206 substantially has an elliptical shape. Here, the light spot will be redefined as a zone inside a contour on which illuminance falls to 1/e² (where e is the base of the natural logarithm) of illuminance at a central portion of the light spot. A width in the radial direction (a long axis direction) of this light spot 206 will be defined as Dr and a width in the circumferential direction (a short axis direction) thereof will be defined as Dc.

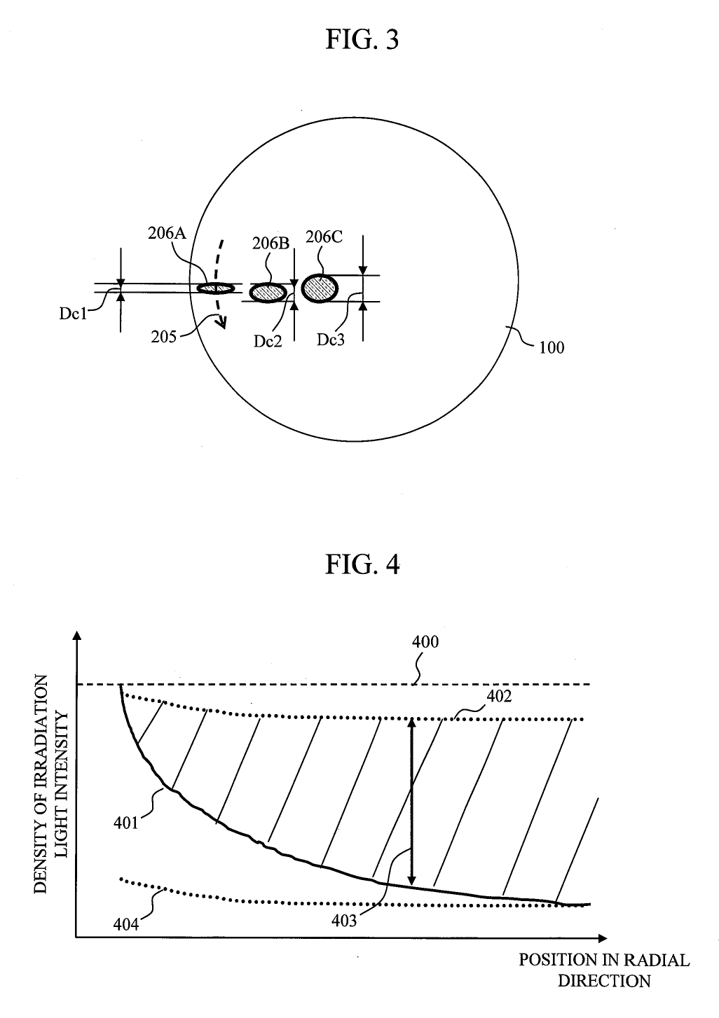

As described previously, main scanning and sub-scanning of the light spot are produced on the semiconductor wafer 100 in a relative manner using the rotary stage 103 and the rectilinear stage 104 of the moving stage 102. In other words, the light spot 206 can be moved on the semiconductor wafer 100 spirally for scanning. An arrow 205 in a dotted line in FIG. 2B and FIG. 3 represents a scan trajectory of the light spot 206. The scan trajectory includes a main scanning component and a sub-scanning component. In this embodiment, scanning of the light spot 206 in the radial direction, i.e., sub-scanning of the light spot 206 is carried out from radially inside to radially outside of the semiconductor wafer 100. However, sub-scanning may also be performed in the reverse direction.

Processing to change the dimension of the light spot to be executed by the surface inspection device of the present invention will be described with reference to FIG. 3. As described previously, according to the present invention, the lighting device 200 is controlled to change the dimension of the light spot based on the position of the light spot on the semiconductor 100 obtained by the inspection coordinate detection mechanism 106. A dimension (width), in the circumferential direction, of a light spot 206A located at an outer peripheral portion will be defined as Dc1, a dimension (width), in the circumferential direction, of a light spot 206B located at a radially intermediate portion will be defined as Dc2, and a dimension (width), in the circumferential direction, of a light spot 206C located at a radially inner portion, i.e., a central portion will be defined as Dc3. Note that Dc1<Dc2<Dc3. That is, the dimension (width) of the light spot in the circumferential direction is increased as the light spot moves from the outer peripheral portion toward the central portion.

The present invention only requires increasing the dimension of the light spot in the circumferential direction gradually from the outer peripheral portion toward the central portion. Accordingly, the dimension of the light spot in the circumferential direction at the outer peripheral portion may be defined as a reference and the dimension of the light spot in the circumferential direction may gradually be expanded as the light spot approaches the central portion. Instead, the dimension of the light spot in the circumferential direction at the radially inner portion may be defined as a reference and the dimension of the light spot in the circumferential direction may gradually be reduced as the light spot approaches the outer peripheral portion. Alternatively, a dimension of the light spot in the circumferential direction in a predetermined reference position in the radial direction may be defined as a reference, and the dimension of the light spot in the circumferential direction may gradually be reduced as the light spot moves from the reference position toward the outer peripheral portion while the dimension of the light spot in the circumferential direction may gradually be expanded as the light spot moves from the reference position toward the central portion.

At the time of inspection scanning, assuming that a distance in the radial direction from the center of the wafer to the center of the light spot 206 is Rc, then the dimension (width) Dc of the light spot in the circumferential direction is found by the following formula.

Dc∝Dm×(Rm/Rc) Formula 2

Dc: dimension of light spot in circumferential direction (width in short axis direction)

Rc: position in radial direction of light spot (distance from center of wafer)

Dm: dimension of light spot in circumferential direction as reference (width in short axis direction of light spot)

Rm: position in radial direction of light spot as reference (distance from center of wafer)

As described above, according to this example, the dimension of the light spot in the circumferential direction is gradually increased from the outer peripheral portion toward the central portion. It is to be noted that the width Dr of the light spot in the radial direction is constant. Accordingly, the area of the light spot is gradually increased from the outer peripheral portion toward the central portion. However, a linear velocity in the circumferential direction on the wafer is gradually reduced from the outer peripheral portion toward the central portion. For this reason, the density of irradiation light intensity remains constant at the outer peripheral portion as well as at the central portion.

Note that the beam expander 202 in the lighting device 200 may be used as a means for changing the dimension of the light spot 206 in the circumferential direction. The beam expander 202 is configured to be capable of changing a focal or inter-lens distance and thereby changing a magnification, for example. Thus, the beam expander 202 can change a beam width and to change the dimension in the circumferential direction (the width in the short axis direction) of the light spot.

The density of irradiation light intensity on the semiconductor wafer 100 will be described with reference to FIG. 4. FIG. 4 is a view showing the density of irradiation light intensity on the semiconductor wafer 100. In the drawing, the horizontal axis indicates the position in the radial direction on the semiconductor wafer 100, i.e., the distance from the center thereof. The vertical axis indicates the density of irradiation light intensity of the light spot of the laser beam. A curve 401 in a solid line indicates the density of irradiation light intensity according to a conventional surface inspection device. Although the density of irradiation light intensity is high at the central portion, the density of irradiation light intensity is gradually reduced toward the outer peripheral portion. A straight dashed line 400 indicates a limit value for the density of irradiation light intensity necessary for avoiding a change in the physical property of the semiconductor wafer 100. The density of irradiation light intensity on the semiconductor wafer 100 must be lower than this limit value.

A curve 402 in a dashed line indicates the density of irradiation light intensity according to the surface inspection device of the present invention. As described previously, the linear velocity in the circumferential direction on the wafer is gradually reduced from the outer peripheral portion toward the central portion. However, according to the present invention, the density of irradiation light intensity remains constant because the area of the light spot is gradually increased from the outer peripheral portion toward the central portion. In the example illustrated with the dashed-line curve 402, the density of irradiation light intensity at the radially inner portion is defined as a reference value. The density of irradiation light intensity on the wafer 100 therefore remains substantially equal to the reference value at the radially inner portion throughout the range from the radially inner portion to the outer peripheral portion. This reflects the results of defining, as the reference value, the dimension Dc3 the light spot 206 in the circumferential direction at the radially inner portion on the wafer and gradually reducing the dimension of the light spot 206 in the circumferential direction toward the outer peripheral portion. A difference 403 between the two curves 401 and 402 indicates the amount of increase in the density of irradiation light intensity.

Meanwhile, in the case of a curve 404 in a dashed line, the density of irradiation light intensity at the outer peripheral portion is defined as the reference value. The density of irradiation light intensity on the wafer 100 therefore remains substantially equal to the reference value at the outer peripheral portion throughout the range from the radially inner portion to the outer peripheral portion. This reflects the results of defining, as the reference value, the dimension Dc1 the light spot 206 in the circumferential direction at the outer peripheral portion on the wafer and gradually increasing the dimension of the light spot 206 in the circumferential direction toward the radially inner portion.

In the case of the dashed-line curve 404, the density of irradiation light intensity is sufficiently smaller than the limit value 400 for the density of irradiation light intensity. In this case, the value of the density of irradiation light intensity may be set greater by increasing the intensity of the laser beam. The value of the density of irradiation light intensity must be smaller than the limit value 400 for the density of irradiation light intensity in this case as well.

As described above, this embodiment makes it possible to achieve the constant density of irradiation light intensity per unit time on the wafer surface by changing the dimension of the light spot 206. Thus, a variation or fluctuation in inspection accuracy can be avoided. According to the conventional surface inspection device, the density of irradiation light intensity at the central portion of the wafer is set to a value close to the limit value as indicated with the solid-line curve 401. As a consequence, the density of irradiation light intensity becomes considerably smaller than the limit value at the outer peripheral portion. In other words, the inspection accuracy tends to be reduced at the outer peripheral portion. According to the present invention, the density of irradiation light intensity can have a constant value close to the limit value across the entire wafer as indicated with the dashed-line curve 402. Thus, the inspection accuracy is improved and a variation or fluctuation in the inspection accuracy can therefore be avoided.

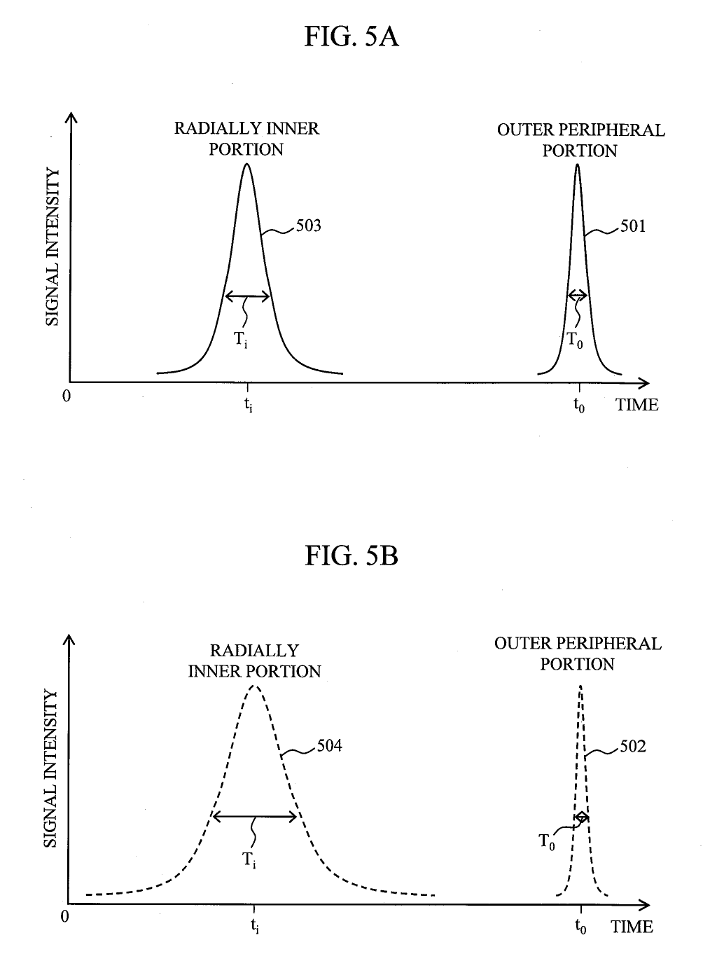

FIG. 5A shows an example of the scattered light detection signal from a conventional light detector 212. The horizontal axis indicates the time and the vertical axis indicates the signal intensity. Since an angular velocity of the semiconductor wafer 100 in rotation motion is constant, the linear velocity the light spot 206 in the circumferential direction at the outer peripheral portion is greater than that at the radially inner portion. For this reason, the time taken for the foreign object on the semiconductor wafer 100 to traverse the light spot 206 is shorter when the foreign object is located at the outer peripheral portion than when the foreign object is located at the radially inner portion. Accordingly, a width of a time-varying waveform representing the signal intensity of the scattered light detection signal obtained from the light detector 212 via the amplifier 121 is generally smaller at the outer peripheral portion as shown in FIG. 5A. A half width To of a waveform 501 of the scattered light detection signal at the outer peripheral portion is smaller than a half width Ti of a waveform 502 of the scattered light detection signal at the radially inner portion.

FIG. 5B shows an example of the scattered light detection signal from the light detector 212 of the present invention. The horizontal axis indicates the time and the vertical axis indicates the signal intensity. Here, a case is assumed in which the dimension of the light spot 206 in a reference position between the outer peripheral portion and the central portion is defined as a reference, and the dimension of the light spot 206 in the circumferential direction is made smaller than the reference value at a position radially outside of the reference position while the dimension of the light spot 206 in the circumferential direction is made greater than the reference value at a position radially inside of the reference position. A half width Ti of a waveform 504 of the scattered light detection signal at the radially inner portion is greater than that of the conventional example shown in FIG. 5A. Meanwhile, a half width Ti of a waveform 502 of the scattered light detection signal at the outer peripheral portion is smaller than that of the conventional example shown in FIG. 5A.

As described above, the width or particularly, the half width of the scattered light detection signal from the light detector 212 can be altered by changing the dimension of the light spot 206 in the circumferential direction. For example, it is only necessary to reduce the dimension in the circumferential direction of the light port 206 at the outer peripheral portion in order to further reduce the half width To of the waveform 502 of the scattered light detection signal at the outer peripheral portion without changing the half width Ti of the waveform of the scattered light detection signal at the radially inner portion. On the other hand, it is only necessary to increase the dimension in the circumferential direction of the light port 206 at the radially inner portion in order to increase the half width Ti of the waveform 504 of the scattered light detection signal at the radially inner portion without changing the half width To of the waveform of the scattered light detection signal at the outer peripheral portion.

Next, a method of setting the sampling interval ΔT for the A/D converter 122 will be described. The sampling interval ΔT is usually constant during the inspection of the semiconductor wafer 100. Accordingly, since the waveform 503 or 504 of the scattered light detection signal at the radially inner portion generally has a large signal width, a necessary number of digital signals can be obtained even when sampling is performed at a given sampling interval ΔT. However, since the waveform 501 or 502 of the scattered light detection signal at the outer peripheral portion has a small signal width, the necessary number of digital signals might not be obtained when sampling is performed at the given sampling interval ΔT. In particular, it is highly likely that the necessary number of digital signals cannot be obtained when the signal width of the waveform 502 of the scattered light detection signal at the outer peripheral portion is relatively small as in the present invention.

According to the present invention, the sampling interval ΔT for the A/D converter 122 is set to a predetermined value. Specifically, the sampling interval ΔT is appropriately set so that sampling can be performed at a sufficient temporal resolution even when the signal width of the waveform 502 of the scattered light detection signal at the outer peripheral portion is relatively small. For example, if the half width of the waveform 502 of the scattered light detection signal at the outer peripheral portion is To, then the sampling interval ΔT is found by a formula ΔT=To÷n. Here, the value n may be set to 10, for example. Thus, in this example, a sufficient number of digital data can be obtained even from the waveform having the relatively small half width To. In other words, this example makes it possible to ensure a sufficient temporal resolution even for the waveform having the relatively small half width To.

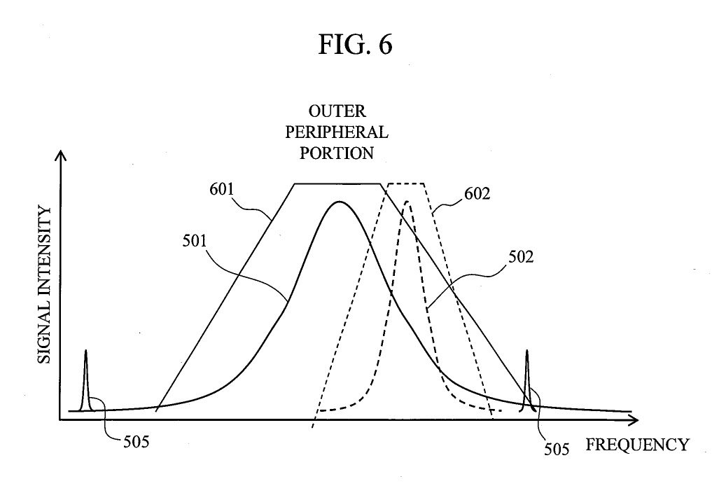

Processing performed by the variable filter 124 and the subtractor 123 of the surface inspection device of the present invention will be described with reference to FIG. 6. FIG. 6 shows examples of the scattered light detection signals from the light detector 212. The horizontal axis indicates the frequency and the vertical axis indicates the signal intensity. A curve 501 in a solid line indicates a waveform of the scattered light detection signal at the outer peripheral portion according to the conventional surface inspection device and a curve 502 in a dashed line indicates a waveform of the scattered light detection signal at the outer peripheral portion according to the surface inspection device of the present invention. It is apparent from the comparison between the two curves 501 and 502 that the waveform of the scattered light detection signal at the outer peripheral portion is reduced in size in this example.

This reflects a result of setting the dimension of the light spot 206 in the circumferential direction at the outer peripheral portion smaller than the reference value in this example. The waveform shape of the scattered light inspection signal varies depending on the dimension of the light spot 206 in the circumferential direction. When the dimension of the light spot 206 in the circumferential direction is reduced, the waveform width of the scattered light inspection signal becomes smaller. When the dimension of the light spot 206 in the circumferential direction is increased, the waveform width of the scattered light inspection signal becomes greater.

The variable filter 124 and the subtractor 123 are configured to remove undesired signal components 505 from the scattered light detection signal. The undesired signal components 505 include background scattered light noise and system noise from stage motors and the like, which inevitably occur. The frequencies of the undesired signal components 505 do not depend on the width or the half width of the scattered light detection signal.

Trapezoids 601 and 602 represent signal ranges, i.e., cut-off frequencies to be removed by the variable filter 124 and the subtractor 123. The variable filter 124 and the subtractor 123 remove signal components which are located outside each of the trapezoids 601 and 602 from the scattered light detection signal detected by the light detector 212. Accordingly, the cut-off frequencies are set so as to correspond to the waveform shape of the scattered light detection signal. In other words, the cut-off frequencies are set based on the dimension of the light spot 206 in the circumferential direction.

Each trapezoid is defined by an upper base and two oblique sides. The cut-off frequencies remove digital values having predetermined sizes in predetermined signal regions from the digital signals. As illustrated in the drawing, the undesired signal components 505 are removed more easily when the signal width of the scattered light detection signal is smaller. Specifically, it is easier to remove the undesired signal components 505 from the scattered light detection signal indicated with the curve 502 than to remove the undesired signal components 505 from the scattered light detection signal indicated with the curve 501. Thus, the undesired signal components 505 can be removed at higher accuracy when the undesired signal components 505 is removed from the scattered light detection signal indicated with the curve 502.

A method of setting the cut-off frequencies by using the parameter computing unit 111 will be described. A center frequency of a filter frequency range is found by the following formula.

fc=1÷((1÷rθ)×(Dc÷π×Rc)) Formula 3

rθ: number of revolutions of rotary stage 103

Dc: dimension in circumferential direction (width in short axis direction) of light spot

Rc: position in radial direction (distance from wafer center) of light spot

In this way, according to the present invention, the undesired signal components 505 can be removed easily and reliably from the scattered light detection signal. As a consequence, a defect or foreign object can be accurately detected independently of noise. According to the surface inspection device of the present invention, the detection sensitivity SNR for a foreign object or defect is obtained by the following formula.

SNR=√(fc÷fx) Formula 4

SNR: signal to noise ratio

fc: frequency of scattered light detection signal before dimension of light spot in circumferential direction is changed

fx: frequency of scattered light detection signal after dimension of light spot in circumferential direction is changed

As shown in Formula 3, the center frequency of the filter frequency range is a function of the dimension Dc of the light spot in the circumferential direction. Accordingly, the detection sensitivity SNR is obtained by the following formula. As apparent from this formula, the detection sensitivity SNR improves in response to the change in the dimension of the light spot in the circumferential direction.

SNR=√(Dc÷Dx) Formula 5

Dc: value after dimension of light spot in circumferential direction is changed

Dx: value before dimension of light spot in circumferential direction is changed

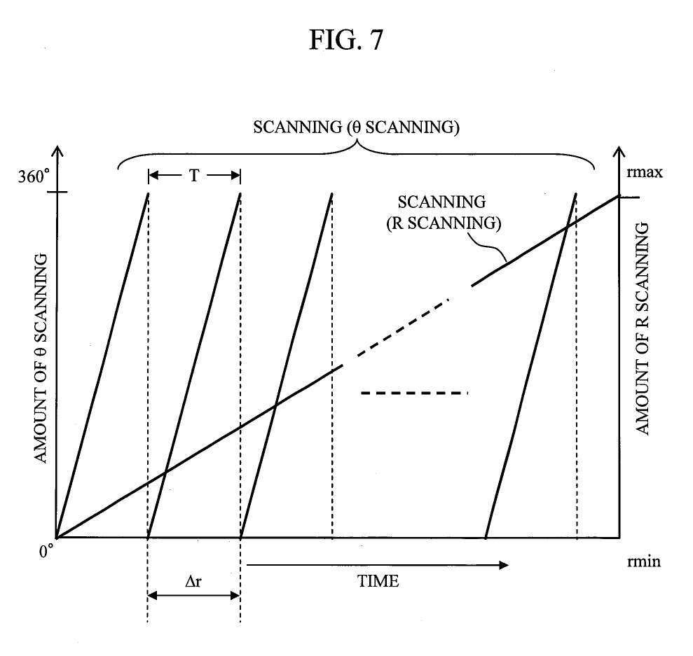

Description will be given with reference to FIG. 7. The vertical axis on the left side in FIG. 7 indicates the main scanning (unit: a scanning angle θ in the circumferential direction) and the vertical axis on the right side indicates the sub-scanning (unit: a scanning distance r in the radial direction). The horizontal axis indicates the time. In this embodiment, the angular velocity of the semiconductor wafer 100 in rotation motion by means of the rotary stage 103 is constant and a linear velocity of the semiconductor wafer 100 in rectilinear motion by means of the rectilinear stage 104 is constant. Accordingly, a graph representing the main scanning includes straight lines appearing at a cycle T and an inclination thereof indicates the magnitude of the angular velocity in rotation motion. A graph representing the sub-scanning includes a straight line in which the scanning distance r in the radial direction changes from a minimum value to a maximum value and an inclination thereof indicates the magnitude of the linear velocity in rectilinear motion in the radial direction.

The light spot is assumed to move in the radial direction by the amount of Δr per revolution of the semiconductor wafer 100. When the width Dr of the light spot 206 in the radial direction is smaller than the amount of scanning Δr of the light spot 206 in the radial direction per revolution, i.e., when Δr>Dr holds true, a region develops on the semiconductor wafer 100 where no illumination light is radiated during spiral scanning of the light spot 206. In other words, an uninspected gap region develops. Accordingly, a condition is usually set to satisfy Δr<Dr. Thus, the light spot 206 can be moved for scanning substantially on the entire surface of the semiconductor wafer 100.

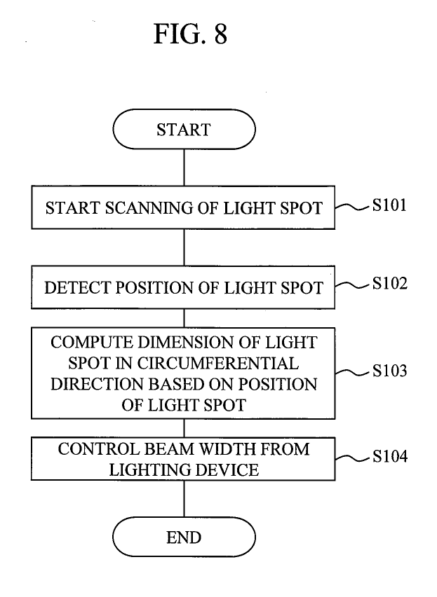

Processing to set the dimension of the light spot according to the surface inspection device of the present invention will be described with reference to FIG. 8. Scanning of the light spot 206 is started in step S101. Specifically, scanning of the light spot 206 on the semiconductor wafer 100 is started with a combination of the main scanning and the sub-scanning. The position of the light spot on the semiconductor wafer 100 is detected in step S102. Specifically, a position of the light spot 206 in a sub-scanning direction is detected. In step S103, the dimension of the light spot in the circumferential direction is computed based on the position of the light spot in the radial direction. The aforementioned formula 2 may be used for this computation. In step S104, the lighting device is controlled based on the dimension of the light spot in the circumferential direction. As described previously, the desired dimension of the light spot in the circumferential direction can be obtained by controlling the beam expander 202 and thereby adjusting the beam width in the circumferential direction.

Although the example of the present invention has been described above, the present invention is not limited only to the above-described example. It is to be easily understood by those skilled in the art that various modifications are possible within the scope of the invention as defined in the appended claims.

### REFERENCE SIGNS LIST

100 semiconductor wafer

101 chuck

102 test object moving stage

103 rotary stage

104 rectilinear stage

105 Z stage

106 inspection coordinate detection mechanism

107 foreign object/defect coordinate detection mechanism

108 host CPU

109 input device

110 display device

111 parameter computing unit

120 illumination and detection optical system

121 amplifier

122 A/D converter

123 subtractor

124 variable filter

125 foreign object/defect determination mechanism

126 particle size calculation mechanism

130 foreign object or defect

200 lighting device

201 light source

202 expander

203 irradiation lens

204 irradiation beam

205 scan trajectory

206 light spot

210 detection optical system

211 condenser lens

212 light detector

400 limit value for density of irradiation light intensity

401 curve of conventional density of irradiation light intensity

402 curve of present density of irradiation light intensity

403 amount of increase in density of irradiation light intensity

404 curve of present density of irradiation light intensity

501 conventional signal distribution at outer peripheral portion

502 present signal distribution at outer peripheral portion

503 conventional signal distribution at radially inner portion

504 present signal distribution at radially inner portion

505 undesired signal component

601 conventional filter frequency range

602 present filter frequency range

1. A surface inspection device comprising:
a test object moving stage configured to move a test object straight in a radial direction while rotating the test object;
a lighting device configured to form a light spot of a laser beam on a surface of the test object;
an inspection coordinate detection device configured to detect a position of the light spot on the test object;
a light detector configured to detect scattered light from the light spot and to convert the scattered light into a scattered light detection signal;
an A/D converter configured to convert the scattered light detection signal into digital data; and
a foreign object/defect determination unit configured to determine whether there is any of a foreign object and a defect on the surface of the test object based on the digital data obtained by the A/D converter, wherein
the lighting device is configured to change a dimension of the light spot in a circumferential direction based on a position of the light spot in the radial direction obtained by the inspection coordinate detection device, and is configured to make density of irradiation light intensity of the light sport constant while the light spot is being moved for scanning between an outer peripheral portion and a central portion on the test object.

2. The surface inspection device according to claim 1, wherein a dimension Dc of the light spot in the circumferential direction is determined by the following formula based on a reference position defined on the test object:
Dc∝Dm×(Rm/Rc),
in which
Dc: the dimension of the light spot in the circumferential direction,
Rc: the position of the light spot in the radial direction,
Rm: a position of the reference position in the radial direction, and
Dm: a dimension of the light spot in the circumferential direction at the reference position.

3. The surface inspection device according to claim 1, wherein
the foreign object/defect determination unit has a variable filter function to remove unnecessary noise from the digital data obtained by the A/D converter,
the variable filter function has a cut-off frequency being a parameter to determine a frequency range of a signal to be removed from the digital data, and
the cut-off frequency is controlled based on a waveform shape of the scattered light detection signal obtained by the light detector.

4. The surface inspection device according to claim 1, wherein the density of irradiation light intensity of the light spot is set to a value such that a change in a physical property of the test object due to energy irradiation intensity on the test object is avoided.

5. The surface inspection device according to claim 1, wherein a sampling frequency for the A/D converter is set based on a half width of a waveform of the scattered light detection signal obtained by the light detector when the light spot is located at an outermost peripheral portion of the test object.

6. The surface inspection device according to claim 1, wherein
the lighting device comprises:
a light source configured to generate a laser beam; and
a beam expander configured to adjust a beam width of the laser beam, and
the beam expander is configured to change the dimension of the light spot in the circumferential direction based on the position of the light spot in the radial direction obtained by the inspection coordinate detection device.

7. The surface inspection device according to claim 1, wherein the inspection coordinate detection device detects a main scanning coordinate position θ representing an angular coordinate of the light spot in the circumferential direction and a sub-scanning coordinate position R representing a rectilinear coordinate in the radial direction of the light spot.

8. The surface inspection device according to claim 7, further comprising:
a foreign object/defect coordinate detection unit configured to detect the main scanning coordinate position θ and the sub-scanning coordinate position R of any of the foreign object and the defect determined by the foreign object/defect determination unit, on the basis of the main scanning coordinate position θ and the sub-scanning coordinate position R detected by the inspection coordinate detection device.

9. The surface inspection device according to claim 1, wherein a dimension Dr of the light spot in the radial direction is greater than an amount of scanning Δr in the radial direction per revolution of the test object.

10. A surface inspection method comprising:
a step of moving a test object straight in a radial direction while rotating the test object;
a light spot forming step of forming a light spot of a laser beam on a surface of the test object which is being moved straight while rotated;
an inspection coordinate detecting step of detecting a position of the light spot on the test object;
a light detecting step of detecting scattered light from the light spot and converting the scattered light into a scattered light detection signal;
an analog-to-digital converting step of converting the scattered light detection signal into digital data; and
a foreign object/defect determining step of determining whether there is any of a foreign object and a defect on the surface of the test object based on the digital data, wherein
in the light spot forming step, a dimension of the light spot in a circumferential direction is changed based on a position of the light spot in the radial direction, and density of irradiation light intensity of the light sport is made constant while the light spot is being moved for scanning between an outer peripheral portion and a central portion on the test object.

11. The surface inspection method according to claim 10, wherein a dimension Dc of the light spot in the circumferential direction is determined by the following formula based on a reference position defined on the test object:
Dc∝Dm×(Rm/Rc),
in which
Dc: the dimension of the light spot in the circumferential direction,
Rc: the position of the light spot in the radial direction,
Rm: a position of the reference position in the radial direction, and
Dm: a dimension of the light spot in the circumferential direction at the reference position.

12. The surface inspection method according to claim 10, wherein
the analog-to-digital converting step uses a variable filter function to remove unnecessary noise from the digital data,
the variable filter function has a cut-off frequency being a parameter to determine a frequency range of a signal to be removed from the digital data, and
the cut-off frequency is controlled based on a waveform shape of the scattered light detection signal obtained in the light detecting step.

13. A surface inspection device comprising:
a test object moving stage configured to move a semiconductor wafer straight in a radial direction while rotating the semiconductor wafer;
a lighting device configured to form a light spot of a laser beam on a surface of the semiconductor wafer;
an inspection coordinate detection device configured to detect a position of the light spot on the semiconductor wafer;
a light detector configured to detect scattered light from the light spot and to convert the scattered light into a scattered light detection signal;
an A/D converter configured to convert the scattered light detection signal into digital data; and
a foreign object/defect determination unit configured to determine whether there is any of a foreign object and a defect on the surface of the semiconductor wafer based on the digital data obtained by the A/D converter, wherein
irradiation light from the lighting device is controlled such that density of irradiation light intensity of the light spot is made constant while the light spot is being moved for scanning between an outer peripheral portion and a central portion on the semiconductor wafer.

14. The surface inspection device according to claim 13, wherein while the light spot is being moved for scanning between an outer peripheral portion and a central portion on the test object, the surface inspection device changes a dimension of the light spot in a circumferential direction so that the dimension of the light spot in the circumferential direction is small at the outer peripheral portion and large at the central portion.

15. The surface inspection device according to claim 13, wherein a sampling frequency for the A/D converter is set based on a half width of a waveform of the scattered light detection signal obtained by the light detector when the light spot is located at an outermost peripheral portion of the semiconductor wafer.

16. The surface inspection device according to claim 13, wherein
the foreign object/defect determination unit has a variable filter function to remove unnecessary noise from the digital data obtained by the A/D converter,
the variable filter function has a cut-off frequency being a parameter to determine a frequency range of a signal to be removed from the digital data, and
the cut-off frequency is controlled based on a waveform shape of the scattered light detection signal obtained by the light detector.

17. The surface inspection device according to claim 13, wherein
the foreign object/defect determination unit has a variable filter function to remove unnecessary noise from the digital data obtained by the A/D converter,
the variable filter function has a cut-off frequency being a parameter to determine a frequency range of a signal to be removed from the digital data, and
the cut-off frequency is controlled based on a dimension of the light spot in a circumferential direction.

18. The surface inspection device according to claim 13, wherein a dimension Dc of the light spot in the circumferential direction is determined by the following formula based on a reference position defined on a test object:
Dc∝Dm×(Rm/Rc),
in which
Dc: a dimension of the light spot in a circumferential direction,
Rc: a position of the light spot in the radial direction,
Rm: a position of the reference position in the radial direction, and
Dm: a dimension of the light spot in the circumferential direction at the reference position.

19. The surface inspection device according to claim 13, wherein
the lighting device comprises:
a light source configured to generate a laser beam; and
a beam expander configured to adjust a beam width of the laser beam, and
the beam expander is configured to change a dimension of the light spot in a circumferential direction based on a position of the light spot in the radial direction obtained by the inspection coordinate detection device.
